(19) United States
(12) Patent Application Publication
(10) Pub. No.: US 2022/0253892 A1
(43) Pub. Date: Aug. 11, 2022

(54) LIVE CONTENT SHARING WITHIN A SOCIAL OR NON-SOCIAL NETWORKING ENVIRONMENT WITH RATING AND COMPENSATION SYSTEM

(71) Applicant: Allen Berube, Saco, ME (US)

(72) Inventor: Allen Berube, Saco, ME (US)

(21) Appl. No.: 17/174,086

(22) Filed: Feb. 11, 2021

(51) Int. Cl. G06Q 30/02; G06Q 50/00; H04L 12/58; G06F 16/435

(52) U.S. Cl. CPC G06Q 30/0239; G06Q 50/01; G06F 16/435; H04L 51/32; G06Q 30/0261

(57) ABSTRACT

Provided is a method comprising, determining a current location of at least one first mobile device at a live event; determining that at least one suitably configured second mobile device is within the live event vicinity; capturing live electronic content using the at least one first mobile device; and anonymously sharing the captured live electronic content with the at least one suitably configured second mobile device, voting on the live electronic content by users of the suitably configured second mobile device and ranking the live electronic content based on the number of votes received by each content, wherein the number of votes received by each live electronic content determines the ranking of the content from first to last. Also provided is a method to compensate the content based on the number of votes each content receives. Also provided is an assignment of the content to the owner of the method, process, medium and system.

### TECHNICAL FIELD

This application relates generally to the communication of electronic content and, more specifically, to systems and methods for anonymously sharing of live electronic content within a social or non-social networking environment and voting and ranking the shared content with compensation provided depending on the ranking of the content.

### BACKGROUND

Sharing of electronic content is rapidly increasing among users of such content, such as video clips, audio clips, photographs, live video streams, and the like. Many mechanisms exist for such sharing, from direct transfer of such electronic content from one user to another, such as by way of e-mail, as well as posting of such content to an electronic content sharing website so that the content may be available to visitors of the website. The capabilities of the Internet and associated communication devices have evolved so that more advanced forms of content sharing, including one-on-one video conferencing, such as by way of Skype® and other mechanisms, have become more commonplace.

An innovation of the Internet that has also become popular among users is the creation of human “social” networks, such as Facebook®, Instagram® and Myspace®. In such a network, friends, acquaintances, and other types of human relationships may be explicitly specified and allowed to be connected to each other to stay apprised of the current status and ongoing actions of each other. Such status may also include electronic content, such as photographs, posted by one user to be viewed by other users who have previously been allowed to view such content. These networks require a request to be included and an explicit allowance for the requester to be included. The requester may be denied access to the social network for a number of reasons, so that it is not automatic that a person is included in anyone's social network.

Other traditional methods of sharing electronic content generally require that the person capturing the electronic content to send a communication to the party interested in that content. For example, a person taking photographs at a particular event may send an email to interested parties attaching the photographs. Traditional methods of sharing electronic content do not adequately enable a person capturing electronic content to easily share that content with others that are present at a particular event. For example, a person taking photographs at a concert must undergo the arduous process of identifying friends and family that either attended or didn't attend the concert that are interested in having access to the photographs and emailing that photographs to those individuals.

There is also the opportunity for the individual who captured the electronic content to identify and post the electronic content to an internet based photo sharing website for family and friends to view. The individual who captured the electronic content can email a link of that content to those individuals interested in the photographs. There are some mechanisms for the individual capturing electronic content to provide the content to a group of social contacts in attendance at the event in real-time.

In all these systems the social network needs to be set up before hand to create a specific, finite social network. This requires contacting persons with which you want to share electronic contact, either their own or that of others. Trending is sharing electronic content in real time including photographs, video streaming or audio streaming, and the like. In many cases it is desirable to share the electronic content with uses in a specific geographic proximity, such as people at a sporting event, parade, political gathering and the like, who are not close enough to the action to get a proper view of the activities.

Additionally most captured electronic content is voluntarily shared with social network to which one belongs. There is very little incentive to generate high quality content other than the occasional “like” or other accolade which the network may or may not give. Additionally the ownership of such content is distributed widely to the network without reference to the original content provider. Thus there is a need for compensation for sharers of live electronic content so that the content may have improved quality. Also there is a need for ownership of the content so that distribution may be controlled for exceptional content.

### BRIEF DESCRIPTION OF DRAWINGS

FIG. 1 is a block diagram depicting an exemplary system 100 for implementing anonymous sharing of real-time electronic content.

FIG. 2 is a block diagram depicting an exemplary system 200 for implementing sharing of real-time electronic content.

FIG. 3 is a block diagram depicting an exemplary system 300 for implementing sharing of real-time electronic content.

FIG. 4 is a flow chart illustrating an exemplary method of sharing real-time content.

### SUMMARY OF THE DISCLOSURE

In a first embodiment, disclosed and claimed herein is a method comprising: determining a current location of at least one first mobile device at a live event, by processor, at least one suitably configured second mobile device based on the live event, capturing live electronic content using the at least one first mobile device, sharing the captured electronic content with the at least one suitably configured second mobile device, wherein the at least one first mobile device and the at least one suitably configured second mobile device are anonymous to each other, voting on the captured electronic content by users of the suitably configured second mobile device, wherein the sharing and voting of the captured electronic content is performed anonymously between the sharer and the voter, ranking, by a processor, the previously captured electronic content based on the number of votes each captured content received, wherein the number of votes received by each captured electronic content determines the ranking of the captured content from first to last, and providing compensation to the voted-on captured and shared electronic content based on their position in the ranking, wherein the compensation for each position is either predetermined or adjusted as voting progresses, wherein the compensation is chosen from monetary compensation, gifts, prizes, tickets, points for accumulation for later compensation when a predetermined number of points have been reached or most points during a predetermined time-frame, coupons, and rewards, wherein the electronic content is a photograph, a video stream, an audio recording, or a multimedia message.

In a second embodiment, disclosed and claimed herein is the method of the above embodiment, wherein the voting and ranking is performed within a predetermined time period during or after the event for which the content is being captured.

In a third embodiment, disclosed and claimed herein are methods of the above embodiments, further comprising the step of assigning the captured electronic content to the owner of the method of claim 1 when the captured electronic content is shared.

In a fourth embodiment, disclosed and claimed herein are the methods of the above embodiments, wherein the at least one suitably configured second device scrolls through more than one captured electronic content to selectively choose and rank the electronic content that is being shared from one of the first mobile devices to provide a graduated ranking for the chosen electronic content.

In a fifth embodiment, disclosed and claimed herein are the methods of the above embodiments, wherein the captured electronic content is stored within an electronic photo album; and the electronic photo album is shared with the one or more suitably configured second mobile devices after the event.

In a sixth embodiment, disclosed and claimed herein are the methods of the above embodiments, wherein the current location of any of the mobile devices is determined by monitoring the mobile devices using a global position system.

In a seventh embodiment, disclosed and claimed herein are the methods of the above embodiments, further comprising providing advertising data with the captured electronic content based on the geographic location of the event, on the geographic location of the at least one suitably configured second mobile device, on the sponsor of the event, or on purchaser of advertising content.

In an eighth embodiment, disclosed and claimed herein are the methods of the above embodiments, wherein the processor determines a vicinity associated with the live event and comprising a geographic area proximate the live event, determining at least one suitably configured second mobile device is within the live event vicinity, capturing live electronic content using the at least one first mobile device, sharing the captured electronic content with the at least one suitably configured second mobile device that is determined to be within the event vicinity.

In a ninth embodiment, disclosed and claimed herein is a non-transitory computer-readable medium on which is encoded program code, the program code comprising: program code for determining a current location of at least one first mobile device at a live event, program code for detecting at least one suitably configured second mobile device based on the live event, program code for capturing live electronic content using the at least one first mobile device, program code for sharing the captured electronic content with the at least one suitably configured second mobile device, wherein the at least one first mobile device and the at least one suitably configured second mobile device are anonymous to each other, program code for voting on the captured electronic content by users of the suitably configured second mobile device, wherein the sharing and voting of the captured electronic content is performed anonymously between the sharer and the voter, program code for ranking the previously captured electronic content based on the number of votes each captured content received, wherein the number of votes received by each captured electronic content determines the ranking of the captured content from first to last, and program code for providing compensation to the voted-on captured and shared electronic content based on their position in the ranking, wherein the compensation for each position is either predetermined or adjusted as voting progresses, wherein the compensation is chosen from monetary compensation, gifts, prizes, tickets, points for accumulation for later compensation when a predetermined number of points have been reached or most points during a predetermined time-frame, coupons, and rewards, wherein the electronic content is a photograph, a video stream, an audio recording, or a multimedia message.

In a tenth embodiment, disclosed and claimed herein is the computer-readable medium of the above embodiment, further comprising, program code for assigning the content to the owner of the medium, program code for storing the captured electronic content within an electronic photo album; and program code for anonymously sharing the electronic photo album with the at least one second mobile devices determined to be within the event vicinity.

In an eleventh embodiment, disclosed and claimed herein is the computer-readable medium of the above embodiments, wherein the captured electronic content is anonymously shared with the at least one second suitably configured mobile device immediately as the electronic content is being captured, voted on and ranked.

In a twelfth embodiment, disclosed and claimed herein is the computer-readable media of the above embodiments, wherein the captured electronic content is a photograph, video, audio recording, or a multimedia message.

In a further embodiment, disclosed and claimed herein is a non-transitory computer-readable medium on which is encoded program code, the program code comprising: program code for determining a current location of at least one first mobile device at a live event; program code for determining a live event vicinity associated with the live event and comprising a geographic area proximate the live event; program code for determining at least one suitably configured second mobile devices that are within the live event vicinity; program code for capturing electronic content using the at least one first mobile device; program code for knowingly or anonymously sharing the captured electronic content with the at least one second suitably configured mobile device that is determined to be within the live event vicinity, program code for voting on the live electronic content by users of the suitably configured second mobile device; and program code for ranking the live electronic content based on the number of votes each content receives; wherein the number of votes received by each live electronic content determines the ranking of the content from first to last.

In a further embodiment, disclosed and claimed herein is computer-readable medium of the above claims, wherein the captured electronic content is knowingly or anonymously shared with the at least one second suitably configured mobile device immediately as the electronic content is being captured, voted on and ranked.

In a still a further embodiment, disclosed and claimed herein is a system comprising: a context server configured to determine a current location of at least one mobile device at a live event, an application server configured to determine at least one second suitably configured mobile device based on the live event, a first content server configured to store electronic content that is captured using the at least one first mobile device, a distribution server configured to anonymously share the captured electronic content, a second content server configured to assign the content to the owner of the system, to calculate the number of votes each electronic content received from the suitably configured second device and to provide a ranking of each captured content and notifying the sharer of the content with the calculated ranking.

### DETAILED DESCRIPTION

Systems, methods and media are disclosed to facilitate the knowingly or anonymous sharing of real-time electronic content. The current methods and systems do away with the issues relating to social networking and social contacts, such as, for example, chatting, sharing invasive data, and the like, which is associated with typical social networks. The current disclosure also provides for compensation of the content based on a voting and ranking system of the users. Anyone whose mobile device is suitable configured can share electronic content with anyone and vice versa so that there is no need to request membership in the network and remove the awkwardness of refusing or declining a membership request as well as eliminate continued, after the event, contact. The methods and systems disclosed herein may be used in a variety of contexts and provide various advantages and features.

The sharing of the captured electronic content may be anonymously or it may be knowingly, such as in the case of the typical social media where users are known to each other.

For example a person working at ground level at a professional football game has access to views and content that are not available to people not working the sidelines of the game. But to request to be included in a social network with such a person, who does not consider that person to be a “social connection”, will not result in sharing the electronic content. However the current disclosure provides for methods so that the content not available to a person not working the sidelines can be shared anonymously, with no strings attached. Thus the special content will likely be readily shareable since there are no repercussions to sharing the content. As another example, a person sitting in the front few rows of a sporting event will have better views of the action than someone on the “nose-bleed” section. The electronic content captured by persons in the front few rows can be readily shared with others with less desirable views, again without any need to request inclusion in the social network or flowing and, and perhaps, undesirable further social content.

As used herein the phase “social network” has the dictionary meaning of a network of friends, colleagues, and other personal contacts. It also refers to an online community of people with a common interest who join the community in order to share the common interests. “Social contacts” are persons who have interfaced with each other to form a membership community. “Anonymous sharing” is meant to mean the sharing of electronic content without knowing who is sending the content and who is receiving the content, so that no further contact, other than the sharing of the electronic data ensues.

As used herein the term “electronic content” refers to photographs, video clips, live video streams, audio recordings, textual content, graphical content, multimedia messages, and the like. As used herein “mobile device” refers to a mobile (smart) phone, electronic notepad, a laptop, or other device capable of capturing electronic media and send the media to a processor. As use herein the term “live event vicinity” refers to a vicinity or geographic area around a particular event. As used herein the term “event” refers to any environment, gathering or occurrence that involves one or more individuals.

As used herein the term “at least one of” means that one item may be used in the method or system or more than one without restriction to the absolute number.

As used herein “suitably configured” refers to the property of mobile devices which contain the appropriate software, hardware, internet connectivity, positioning capabilities or combinations thereof, so that electronic content may be anonymously captured, received, displayed, scrolled, and the like. Without the software, hardware, internet connectivity, positioning capabilities or combinations thereof the content could not be shared. For example, a tablet may have downloaded onto it the application that is associated with receiving live contact from a one or more sending device.

The disclosed method discloses a method for a person with a mobile device to capture live content while attending a live event, such as, for example, a parade, a sporting event, celebration, a concert, political gathering, a newsworthy event or other event in which people may be interested. The method specifically eliminates the need for a “social network” or “social contacts” wherein the users of the method remain anonymous. Social networks entities require that people preregister with the network and become a contact. Often there are people at live events who are capturing live electronic content and have the content available for sharing, but people who may be interested in the content are unaware of the person capturing the content and are therefore not capable of receiving the content of interest. The current disclosure eliminates that problem so that anyone with a suitably configured mobile device is capable of receiving electronic content even without knowing the person capturing the content and preregistering with that person so that the content can be shared. In many aspects this is desirable in that often social networks become extremely large and cumbersome. And often some people do not wish to be in a social network in perpetuity. With the current disclosure a person who is in the “vicinity” can receive the electronic content and the next day when they are not in the vicinity are no longer connected.

Mobile devices suitable for the current disclosure include, for example, cell phones, smart phone, tablets, personal electronic assistants, camera, laptop, notebooks, and the like.

The method and system of the current disclosure may determine the location of the mobile devices by way of technologies, including, for example, GPS technology, assisted GPS technology, WiFi positioning system, cell-phone triangulation, EPS technology, Internet-based technology, and the like, which may include monitoring the location and/or coordinates of the mobile device. The method and system may compare the coordinates of the mobile device user to a live event vicinity. The system may define the parameters of a vicinity, such as for example, 500 feet, 2000 feet, 1 mile, 2 mile and the like. The vicinity may be determined by the first mobile device so that the person capturing the content has control over how far the content can be shared. The method and system may be configured to detect and determine whether at least one mobile device which is suitably configure to receive electronic content is within the live event vicinity. The method and system may use such techniques as, for example, GPS technology, assisted GPS technology, WiFi positioning system, cell-phone triangulation, EPS technology, Internet-based technology, and the like to determine whether at least one mobile device suitably configured to receive electronic content is within the live event vicinity.

One or more networks servers, such as, for example distribution servers, context servers, application servers, content servers and the like may be connected through a network, such as, for example, the internet, a local area network, wide area network, Bluetooth, Wi-Fi, or other suitable networks. The network servers may be implemented using hardware, software, firmware, manual processing, and combinations thereof. The servers may interface with the mobile devices which capture, share and receive electronic content, such as, for example, through software modules located on the network server, the mobile devices, or both. These various servers may participate in a cloud computing paradigm. These various servers may be implemented on a single computer system, or multiple computer systems. The sharing of real-time electronic content to mobile devices suitably configured to receive such content may be implemented through one or more software modules executed by the one or more network servers, possibly in cooperation with one or more content sharing applications executed by a mobile device.

The designation of “first mobile device” means the mobile device which records the electronic content from the live event and shares such content. The designation of a “second mobile device” means a device which can receive the electronic content that is being shared by the first mobile device. It should be understood that the first and second mobile devices can reverse roles, in that the second mobile device can capture the electronic content of a live event and share it, thus becoming the “first mobile device, while the original first mobile device becomes the “second mobile device” and receives the shared electronic content. This role reversal may occur many times during the course of a live event.

One or more mobile devices can be used to capture and transmit the live electronic content. These devices contain functionality to capture electronic content, such as, for example, cameras. As well, one or more suitably configured second mobile devices can receive the captured and shared electronic content. The method is not restricted to only one mobile device or one suitably configured second mobile device to which the live electronic content is anonymously shared.

The live content may be captured by a number of different mobile devices and anonymously shared to a number of different mobile devices. The receiving mobile devices may receive the live electronic content as a full size representation, which may be a picture, live video stream, video clips and the like, on the screen of the mobile device. The receiving device may then scroll through the representations, one at a time, until a desired feed or picture is chosen. The live electronic content may also be represented by thumbnails on the screen which can then be chosen by tapping the thumbnail to create a full size representation. As well, more than one electronic content may be chosen on the receiving device such that the user may observe more than one live feed, for example in a split-screen mode.

In certain embodiments of the current disclosure, the capture electronic content that is shared is voted on by the receivers of the content. In some embodiments the more than one content may be voted on and in some embodiments the content may be ranked, for example, ranked first to fifth or first to tenth. The votes may be tabulated and a winner or winners may be contacted.

As stated the current disclosure provides for the users to receive compensation for photos taken at venues based on voting by file sharers. The method includes users capturing electronic content using a mobile device, sharing the captured electronic content with one or more social contacts that are determined to be within the live event vicinity, the voting on the one or more favorite electronic content and receiving compensation.

The compensation is graduated from first to a lower number, such as, for example, second through ten, or twentieth, or lower.

In another embodiment the method includes the process of owning the electronic content by the owner of the non-transitory computer readable medium, or the application which is used in the disclosed methods.

Compensation may be in the form of monetary compensation, a point system that accumulates and leads to monetary compensation, may be non-monetary compensation such as prizes, such as, for example, tickets, items, and the like.

In one embodiment the photos are chosen during the event and the winner or winners are notified during or within a specified short period of time after the event, such as within an hour of the event ending. The time frame for voting may expire after a designated time.

In another embodiment the time for voting may be a longer period after the event, such as, for example, days after the event, but again within a defined designated time period. The owner of the method, system or application will have property ownership of all pictures captured, displayed and voted on. The electronically captured content will be assigned and owned by the owner of the application, method or system, whether individual, business entity such as for example, a corporation, LLC, partnership or other entity.

There may be categories of compensated electronic content, such as, for example, compensation for pictures, streaming media, movie clips, and the like. In these cases the compensation may be commensurate with the amount of the content.

In other embodiments the live electronic content may be stored for viewing either immediately (live) or by others at a later date and area so that the electronic data is not lost, and others who were not in the vicinity may have access, these viewers may or may not be part of a social network.

Referring now to the drawings:

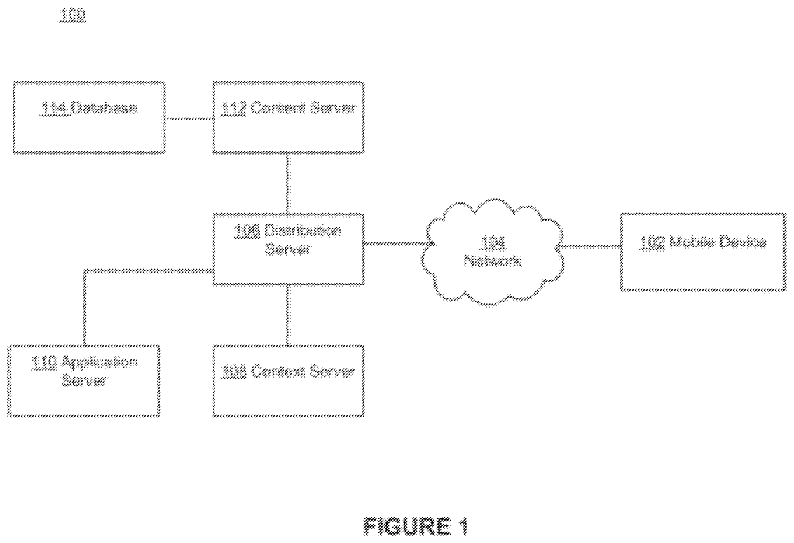

FIG. 1 is a block diagram depicting an exemplary system 100 for implementing anonymous sharing of real-time electronic content. The exemplary system 100 may include a mobile device 102 that is in communications with one or more network servers (e.g., distribution server 106, context server 108, application server 110, and content server 112) through a network 104.

The network 104 may be an Internet, a Local Area Network (LAN), a Wide Area Network (WAN), a private network, a Wi-Fi, or some other suitable type of network associated topology. The mobile device 102 is associated with a particular user. The mobile device 102 generally includes functionality that permits the mobile device 102 to capture electronic content. For example, the mobile device 102 may have a camera that is capable of taking photographs and/or capturing video. Various types of mobile devices 102 may be used. Mobile devices 102 may include, for example, a cell phone, a wireless device, a tablet computer, a personal digital assistant (PDA), a laptop computer, a camera, GPS enabled device, or any device that may be used for capturing and sharing electronic content.

The one or more networks servers (e.g., distribution server 106, context server 108, application server 110, and content server 112) may be implemented using hardware, software firmware, manual processing, or any combination thereof. The anonymous sharing of real-time electronic content may be implemented through one or more software modules executed by the one or more network servers, possibly in cooperation with one or more content sharing applications executed by a mobile device 102.

The distribution server 106 may be connected to the context server 108, application server 110, and content server 112. These various servers may participate in a cloud computing paradigm. These various servers may be implemented on a single computer system, or multiple computer systems. The distribution server 106 may receive information from the mobile device 102 and route the information to one or more of the servers 108, 110 and 112. In addition, the distribution server 106 may distribute information received from one or more of the servers 108, 110 and 112 to the mobile device 102. In some embodiments, the distribution server 106 may receive information from the one or more mobile devices and route the information to the one or more servers. The distribution server 106 may also distribute information received from the one or more servers to one or more mobile devices.

The context server 108 may be used to determine the current location of the mobile device 102 associated with the user. The context server 108 may determine the current location of the mobile device at a live event. The context server 108 may use location based technology, GPS technology, Internet-based technology and the like to determine the location of the user. For example, the context server 108 may monitor or track the coordinates of a mobile device 102 associated with the user. Based on the coordinates, the context server 108 may determine the location of the user. The context server 108 may receive information from the mobile device 102 to determine the current location of the mobile device 102. The context server 108 may send information to the mobile device 102 to determine the current location of the mobile device 102. In some embodiments, the context server 108 may communicate with a location based component of the mobile device 102 to determine the location of the mobile device 102 associated with the user.

In some embodiments, the context server 108 may determine the location of the receiver by monitoring or tracking a mobile device associated with the one or more receiving devices. The context server 108 may receive information from the receiving mobile device and/or send information to the mobile device to determine their current location.

The content server 112 may receive electronic content and/or other information from the mobile device 102 over the network 104. The content server 112 may receive the electronic content from the distribution server 106 which received the electronic content from mobile device 102. The content server 112 may share electronic content and/or other information with the mobile device 102 associated with the user. For example, the content server 112 may anonymously share photographs captured by the mobile device 102 associate with the user to a mobile device. In some embodiments, the distribution server 108 may receive captured electronic content from the content server 112 and anonymously share the captured electronic content with the mobile device 102 or one or more users within the live event vicinity. The captured electronic content may be shared with one or more user in a variety of ways. The one or more user may receive the captured electronic content in a photo album on their mobile device. The one or more user may receive the captured electronic content in a SMS, MMS and the like.

The captured electronic content and/or other data may be stored on the content server 112. The captured electronic content may be stored in the local memory of the content server 112, which may include a RAM, hard disk, removable disks, tape arrays, or any other computer readable medium. Alternatively, or additionally, the content server 112 may have a database 114 for storing captured electronic content and/or other data. The content server 112 may store electronic content captured by the user and/or electronic content capture by one or more users.

The application server 110 may determine a live event vicinity. The application server 110 may access the coordinates for a live event vicinity that is associated with a live event. The live event vicinity may be stored within a local memory of the application server 110. The application server 110 may communicate with the mobile device 102 associated with the user to obtain the live event vicinity. For example, the application server 110 may receive a user defined vicinity or geographical area that is around of a particular event. In some embodiments, the application server 110 may communicate with a party other than the user or a mobile device associated with person other than the user to obtain the live event vicinity. In another embodiment, the live event vicinity may be stored on one or more of the servers. The application server 110 may communicate with the one or more servers to obtain the live event vicinity.

The application server 110 may also determine that one or more users are within the live event vicinity. The application server 110 may communicate with the context server 108 or one or more of the servers to obtain the location of one or more of the user's social contacts. The application server 110 may communicate directly with a mobile device 102 or any device associated with one or more user to determine their location. The application server 110 may compare the coordinates of one or more user to the live event vicinity to determine whether the social contact is within the live event vicinity. The application server 110 may provide an indication to the user that another user is within the live event vicinity. The indication may state that the one or more user will receive any electronic content captured by the mobile device 102 associated with the user. In some embodiments, the application server 110 may communicate a list of one or more users within the live event vicinity to the mobile device 102 associated with the user.

The one or more servers 106, 108, 110 and 112 and/or the mobile device 102 may comprise a computer readable medium such as a random access memory (RAM) coupled to a processor that executes computer-executable program instructions and/or accesses information stored in memory. Such a processor may comprise a microprocessor, an ASIC, a state machine, or other processor, and can be any of a number of computer processors. Such a processor can comprise, or may be in communication with a computer readable medium which stores instructions that, when executed by the processor, cause the processor to perform the steps described herein.

A computer-readable medium may comprise, but is not limited to, an electronic, optical, magnetic, or other storage device capable of providing a processor with computer readable instructions. Other examples comprise, but are not limited to, a floppy disk, CD-ROM, DVD, magnetic disk, memory chip, ROM, RAM, an ASIC, a configured processor, optical storage, magnetic tape or other magnetic storage, or any other medium from which a computer processor can read instructions. The instructions may comprise processor-specific instructions generated by a compiler and/or an interpreter from code written in any suitable computer-programming language, including, for example, C, C++, C#, Visual Basic, Java, Python, Perl, JavaScript, and ActionScript.

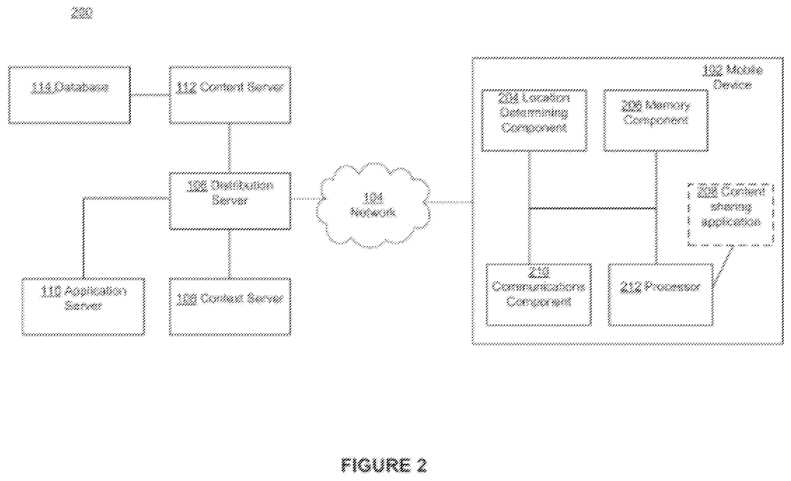

FIG. 2 is a block diagram depicting an exemplary system 200 for implementing sharing of real-time electronic content. The exemplary system 200 illustrates details of the mobile device 102. The mobile device 102 may include a location determining component 204, a memory component 206, a communications component 210, and a processor 212.

The processor 212 may communicate with the location determining component 204, memory component 206, and communications component 210. The processor 212 may process data and execute any of a software module or a executable software program, and cause data to be stored. The operation of the processor 212 may include executing software or coded instructions that may in particular embodiments be associated with the one or more function modules.

The processor 212 may run an executable application. The executable application may be the content sharing application 208. The content sharing application 208 may be used to share electronic content with those that are within a live event vicinity. The content sharing application 208 may be used to capture electronic content. The content sharing application 208 may be used to define an event location. The content sharing application 208 may be used to define a live event vicinity.

The content sharing application 208 may function as a user interface. The content sharing application 208 may receive inputs or commands from the mobile device 102 to activate certain features or components of the mobile device 102. The content sharing application 208 may initiate and/or communicate a command from the mobile device user to operate the appropriate component. The content sharing application 208 may perform some, none, or all of the functions of the mobile device 102.

The memory 206 may be coupled to the processor 212 and may include one or more suitable memory devices, such as one or more random access memories (RAMs), read only memories (ROMs), dynamic random access memories (DRAMs), fast cycle RAMs (FCRAMs), static RAM (SRAMs), field-programmable gate arrays (FPGAs), erasable programmable read-only memories (EPROMs), electrically erasable programmable read-only memories (EEPROMs), microcontrollers, or microprocessors.

The location determining component 204 may be used to determine the location of the mobile device 102. The location determining component 204 may be used to determine the location of the mobile device 102 at a live event. The location determining component 204 may enable and/or include location based functionality (e.g. GPS technology, Internet technology) of the mobile device 102. The location determining component 204 may communicate with the one or more servers to help determine the current location of the mobile device 102. The location determining component 204 may communicate with the communications component 210, memory component 206, and processor 212 to assist in determining the current location of the mobile device 102.

The communications component 210 may be connected to the location determining component 204, memory component 206, and processor 212. The communications component 210 may receive information from the location determining component 204, memory component 206, and processor 212 and route the information to one or more of the servers 106, 108, 110 and 112. In addition, the communications component 210 may receive information from the one or more servers 106, 108, 110 and 112 and route the information to the location determining component 204, memory component 206, and processor 212.

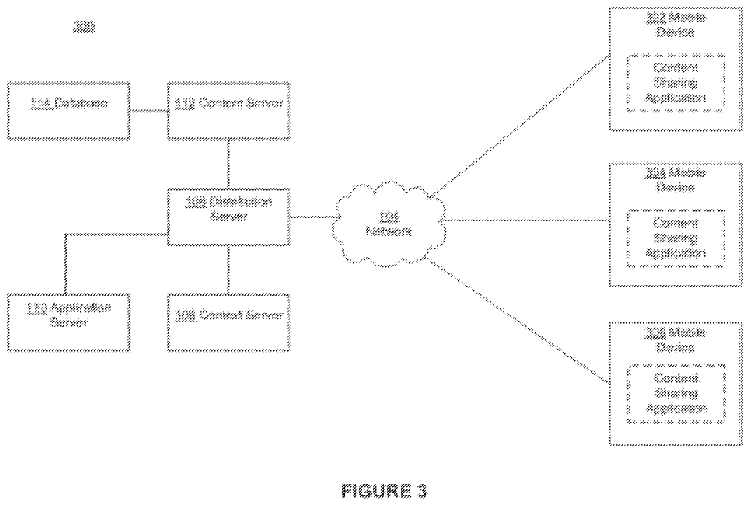

FIG. 3 is a block diagram depicting an exemplary system 300 for implementing sharing of real-time electronic content. As illustrated, the exemplary system 300 may include mobile devices 302, 304 and 306 that are in communications with one or more network servers (e.g., distribution server 106, context server 108, and application server 110) through a network 104 (e.g. the Internet or a private network, etc.). In this embodiment, each of the mobile devices 302, 304 and 306 is anonymously associated with an individual. The mobile device 302 is anonymously associated with a particular user and mobile devices 304 and 306 are associated with one or more other the users. In some embodiments the users are determined to be within a live event vicinity. The mobile devices 302, 304 and 306 may share captured electronic content among each other. As discussed above, electronic content captured by one or more mobile devices can be shared among the user and one or more receiving users that are within a live event vicinity. The distributed electronic content may have advertisements associated with the content when distributed. The captured electronic content may be stored in a shared photo album.

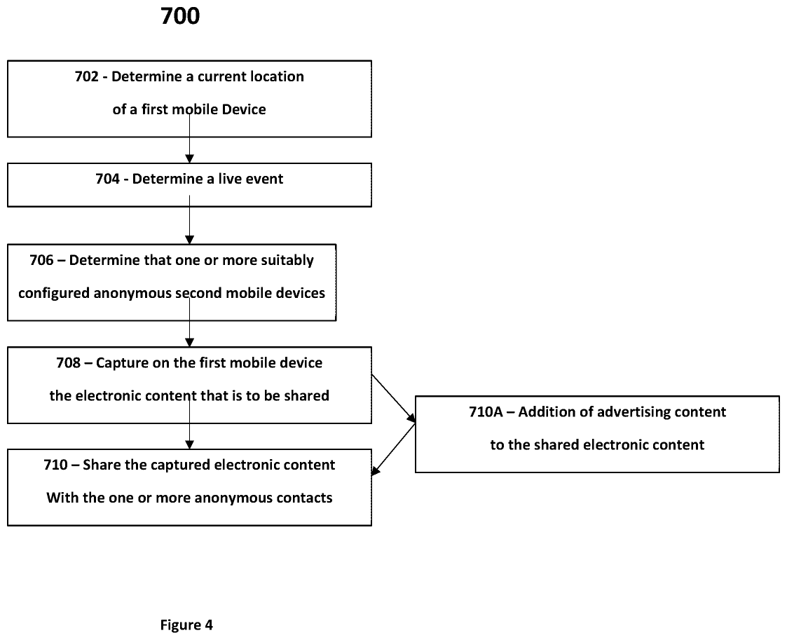

FIG. 4 is a flow chart illustrating an exemplary method of sharing real-time content. At block 702, a current location of a mobile device 102 is determined. The current location of the mobile device 102 is determined at a live event. As described above, the current location of the mobile device user may be determined using GPS technology or Internet technology. The current location of the user may also be determined by tracking the user's cell phone use or any other tracking use, a wireless access point, a cell phone tower, or any other mobile device tracking technology. At block 704, a live event vicinity associated with a live event is determined. The live event vicinity comprises a geographic area proximate the live event. The mobile device 102 associated with the user is within the live event vicinity. The live event vicinity may be determined by accessing the coordinates of the live event vicinity. The coordinates for a live event vicinity may be accessed by obtaining coordinates for the live event vicinity stored on one or more of the servers. The coordinates for a live event vicinity may also be accessed by the user entering the coordinates or some other representation of the location of the live event vicinity within a content sharing application of the mobile device 102.

At block 706, it is determined that one or more receiving users are connected. The current location of one or more receiving users may be monitored or tracked.

At block 708, electronic content may be captured using the mobile device 102 associated with the user.

At block 710, captured electronic content is shared with a user that are determined to be connected to the system. The content server 112 may share captured electronic content and/or other information with one or more receiving users. In some embodiments, the distribution server 106 may share the captured electronic content with the one or more receiving users. The captured electronic content may be shared over a network 104. The captured electronic content may be shared with one or more receiving users in a variety of ways. For example, the one or more receiving users may receive the captured electronic content in a photo album on their mobile the captured electronic content in an SMS, MMS and the like. Further at Block 710A, advertisements may be included in the shared electronic content that has been captured. Such advertisements may take the form of a frame on the shared content displaying the advertisement, a simple logo in a corner, and the like. The advertisement may be focused on the local area of the event, such as a restaurant, a store and the like, or may be focused on a sponsor of the event, such as a soft drink company or a beer company, or it may focus on a global area, such as, for example, a restaurant in London geared toward users in London who with whom the captured electronic content is being shared.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art.

An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Applicants believe the Response to Notice to File Corrected Application Papers is complete and respectfully request acceptance of the submittal.

I claim:

1. A method comprising:
a. determining, by a processor, a current location of at least one first mobile device at a live event,
b. detecting, by processor, at least one suitably configured second mobile device based on the live event,
c. capturing live electronic content using the at least one first mobile device,
d. sharing the captured electronic content with the at least one suitably configured second mobile device, wherein the at least one first mobile device and the at least one suitably configured second mobile device are anonymous to each other,
e. voting on the captured electronic content by users of the suitably configured second mobile device, wherein the sharing and voting of the captured electronic content is performed anonymously between the sharer and the voter,
f. ranking, by a processor, the previously captured electronic content based on the number of votes each captured content received, wherein the number of votes received by each captured electronic content determines the ranking of the captured content from first to last, and
g. providing compensation to the voted-on captured and shared electronic content based on their position in the ranking, wherein the compensation for each position is either predetermined or adjusted as voting progresses, wherein the compensation is chosen from monetary compensation, gifts, prizes, tickets, points for accumulation for later compensation when a predetermined number of points have been reached or most points during a predetermined time-frame, coupons, and rewards
wherein the electronic content is a photograph, a video stream, an audio recording, or a multimedia message.

2. The method of claim 1, wherein the voting and ranking is performed within a predetermined time period during or after the event for which the content is being captured.

3. The method of claim 1, further comprising the step of assigning the captured electronic content to the owner of the method of claim 1 when the captured electronic content is shared.

4. The method of claim 1, wherein the at least one suitably configured second device scrolls through more than one captured electronic content to selectively choose and rank the electronic content that is being shared from one of the first mobile devices to provide a graduated ranking for the chosen electronic content.

5. The method of claim 1, wherein the captured electronic content is stored within an electronic photo album; and the electronic photo album is shared with the one or more suitably configured second mobile devices after the event.

6. The method of claim 1, wherein the current location of any of the mobile devices is determined by monitoring the mobile devices using a global position system.

7. The method of claim 1, further comprising providing advertising data with the captured electronic content based on the geographic location of the event, on the geographic location of the at least one suitably configured second mobile device, on the sponsor of the event, or on purchaser of advertising content.

8. The method of claim 1 wherein the processor determines a vicinity associated with the live event and comprising a geographic area proximate the live event, determining at least one suitably configured second mobile device is within the live event vicinity, capturing live electronic content using the at least one first mobile device, sharing the captured electronic content with the at least one suitably configured second mobile device that is determined to be within the event vicinity.

9. A non-transitory computer-readable medium on which is encoded program code, the program code comprising:
a. program code for determining a current location of at least one first mobile device at a live event,
b. program code for detecting at least one suitably configured second mobile device based on the live event,
c. program code for capturing live electronic content using the at least one first mobile device,
d. program code for sharing the captured electronic content with the at least one suitably configured second mobile device, wherein the at least one first mobile device and the at least one suitably configured second mobile device are anonymous to each other,
e. program code for voting on the captured electronic content by users of the suitably configured second mobile device, wherein the sharing and voting of the captured electronic content is performed anonymously between the sharer and the voter,
f. program code for ranking the previously captured electronic content based on the number of votes each captured content received, wherein the number of votes received by each captured electronic content determines the ranking of the captured content from first to last, and
g. program code for providing compensation to the voted-on captured and shared electronic content based on their position in the ranking, wherein the compensation for each position is either predetermined or adjusted as voting progresses, wherein the compensation is chosen from monetary compensation, gifts, prizes, tickets, points for accumulation for later compensation when a predetermined number of points have been reached or most points during a predetermined time-frame, coupons, and rewards wherein the electronic content is a photograph, a video stream, an audio recording, or a multimedia message.

10. The computer-readable medium of claim 9, further comprising, program code for assigning the content to the owner of the medium, program code for storing the captured electronic content within an electronic photo album; and program code for anonymously sharing the electronic photo album with the at least one second mobile devices determined to be within the event vicinity.

11. The computer-readable medium of claim 10, wherein the captured electronic content is anonymously shared with the at least one second suitably configured mobile device immediately as the electronic content is being captured, voted on and ranked.

12. The computer-readable medium of claim 10, wherein the captured electronic content is a photograph, video, audio recording, or a multimedia message.

13. A system comprising:
a. a context server configured to determine a current location of at least one mobile device at a live event,
b. an application server configured to determine at least one second suitably configured mobile device based on the live event,
c. a first content server configured to store electronic content that is captured using the at least one first mobile device,
c. distribution server configured to anonymously share the captured electronic content,
d. a second content server configured to assign the content to the owner of the system, calculate the number of votes each electronic content received from the suitably configured second device and provide a ranking of each captured content and notifying the sharer of the content with the calculated ranking.
